(19) United States
(12) Patent Application Publication
(10) Pub. No.: US 2024/0238764 A1
(43) Pub. Date: Jul. 18, 2024

(54) HYDROCARBON REDUCTION CATALYST AND VEHICLE EXHAUST GAS PURIFICATION DEVICE COMPRISING THE SAME

(71) Applicants: Hyundai Motor Company, Seoul (KR); Kia Corporation, Seoul (KR); SEOUL NATIONAL UNIVERSITY R&DB FOUNDATION, Seoul (KR)

(72) Inventors: Hyokyung Lee, Anyang (KR); Do Heui Kim, Seoul (KR); Sungha Hwang, Seoul (KR); Eun Won Lee, Seoul (KR)

(21) Appl. No.: 18/519,999

(22) Filed: Nov. 27, 2023

(30) Foreign Application Priority Data
Jan. 12, 2023 (KR) 10-2023-0004646

(51) Int. Cl. B01J 23/44; B01D 53/94; B01J 23/00; B01J 35/00; B01J 37/08; F01N 3/28

(52) U.S. Cl. CPC B01J 23/44; B01D 53/94; B01J 23/002; B01J 35/0066; B01J 37/08; F01N 3/2803; B01D 2255/1023; B01D 2255/2061; B01D 2255/2063; B01D 2255/2065; B01D 2255/2066; B01D 2255/2068; B01D 2255/20715; B01D 2255/407; B01D 2255/912; B01D 2257/7022; B01D 2258/012; B01J 2523/36; B01J 2523/3706; B01J 2523/3712; B01J 2523/3718; B01J 2523/3725; B01J 2523/48; F01N 2370/02

(57) ABSTRACT

Provided is a hydrocarbon reduction catalyst including a carrier including a cerium-zirconium composite oxide, and palladium supported on the carrier, wherein the palladium is included in an amount of about 1 wt % to about 10 wt % based on a total weight of the catalyst.

### CROSS-REFERENCE TO RELATED APPLICATION

This application claims under 35 U.S.C. § 119(a) the benefit of Korean Patent Application No. 10-2023-0004646 filed in the Korean Intellectual Property Office on Jan. 12, 2023, the entire contents of which are incorporated herein by reference.

### BACKGROUND

### Technical Field

The present disclosure relates to a hydrocarbon reduction catalyst that has excellent performance in reducing hydrocarbon emissions in a cold start region, which is a low temperature region at the startup beginning of gasoline vehicles, and to a vehicle exhaust gas purification device including the same.

### Background

In order to reduce exhaust gas in gasoline vehicles, three way catalyst (TWC) technology is used as a post process system. The three way catalyst (TWC) technology is applied to simultaneously remove harmful exhaust gases such as carbon monoxide (CO), hydrocarbon (HC), and nitrogen oxide (NOₓ), wherein the carbon monoxide and the hydrocarbon are simultaneously oxidized and reduced by alternating fuel lean and fuel rich atmospheres in the vehicle engines.

However, a three way catalyst, when sufficiently warmed up by an increase in a temperature of the exhaust gases, may purify 99% or more of the hydrocarbon, but there is still a limit to reducing the hydrocarbon emitted in a cold start region which is a low temperature region at the beginning startup of the vehicles.

In the cold start region where the three way catalyst is not activated yet, about 60% or more of the total hydrocarbon emitted from a tail pipe of gasoline vehicles is emitted, when evaluated in an FTP75 mode, which is an exhaust gas emission certification mode.

In addition, as the exhaust gas temperature gradually decreases due to a high-efficiency engine technology applied in order to improve fuel efficiency and cope with strengthened regulations, it is increasingly required of purifying the hydrocarbon emitted in the cold start region, which is a low temperature region at the startup beginning.

### SUMMARY

One embodiment provides a hydrocarbon reduction catalyst that has excellent performance in reducing hydrocarbons emitted in a cold start region, which is a low temperature region at the startup beginning.

Another embodiment provides a vehicle exhaust gas purification device including the hydrocarbon reduction catalyst.

In one embodiment, a hydrocarbon reduction catalyst is provided that comprises: a cerium-zirconium composite oxide, and palladium, wherein the palladium is in an amount of about 1 wt % to about 10 wt % based on a total weight of the hydrocarbon reduction catalyst. Suitably, the cerium-zirconium composite oxide is associated with a carrier. The palladium suitably also may be associated with the carrier.

According to one embodiment, a hydrocarbon reduction catalyst includes a carrier including a cerium-zirconium composite oxide and palladium supported on the carrier, wherein the palladium is included in an amount of about 1 wt % to about 10 wt % based on a total weight of the hydrocarbon reduction catalyst.

The palladium may be included in an amount of about 4 wt % to about 5 wt % based on a total weight of the hydrocarbon reduction catalyst.

The cerium-zirconium composite oxide may be a composite or solid solution of cerium oxide (CeO₂) and zirconium oxide (ZrO₂).

The cerium-zirconium composite oxide may include cerium oxide in an amount of about 20 wt % to about 60 wt % based on a total weight of the cerium-zirconium composite oxide.

The cerium-zirconium composite oxide may include zirconium oxide in an amount of about 40 wt % to about 80 wt % based on a total weight of the cerium-zirconium composite oxide.

The cerium-zirconium composite oxide may further include a functional element including La, Y, Pr, Nd, or a combination thereof.

The functional element may be present in an amount of about 5 wt % to about 24 wt % based on a total weight of the cerium-zirconium composite oxide.

The functional element may be present in an amount of about 5 wt % to about 12 wt % based on a total weight of the cerium-zirconium composite oxide.

The cerium-zirconium composite oxide is selected from the group consisting of Pd/Ce_{0.4}Zr_{0.5}La_{0.05}Y_{0.05}O₂, Pd/Ce_{0.31}Zr_{0.45}La_{0.06}Y_{0.12}Nd_{0.06}O₂, Pd/Ce_{0.21}Zr_{0.72}La_{0.02}Nd_{0.05}O₂, Pd/Ce_{0.4}Zr_{0.55}Pr_{0.05}O₂, and a combination thereof. Preferably, the cerium-zirconium composite oxide may be Pd/Ce_{0.4}Zr_{0.5}La_{0.05}Y_{0.05}O₂.

The hydrocarbon reduction catalyst may be configured to be subjected to aging at a temperature of about 800° C. to about 1000° C.

The hydrocarbon reduction catalyst may have an adsorption amount of propene (C₃H₆) of about 100 μmol/g_{cat} to about 600 μmol/g_{cat} at an air-fuel ratio (λ) of 1 or more.

According to another embodiment, a vehicle exhaust gas purification device, which is provided on an exhaust pipe connected to an exhaust side of the engine to purify an exhaust gas of the engine, including a housing disposed on the exhaust pipe and configured to receive the exhaust gas discharged from the engine, pass the received exhaust gas through the vehicle gas purification device, and discharge the passed exhaust gas rearward; a front-end catalyst built into the housing and configured to store hydrocarbons included in exhaust gas flowing into the housing through a front end of the housing; and a rear-end catalyst built into the housing and configured to purify exhaust gas passing through the front-end catalyst before it flows out to the rear end of the housing.

The front-end catalyst may include a first carrier including a cerium-zirconium composite oxide, and palladium supported on the first carrier, wherein palladium is included in an amount of about 1 wt % to about 10 wt % based on a total weight of the front-end catalyst. Preferably, the palladium may be in an amount of about 4 wt % to about 5 wt % based on a total weight of the hydrocarbon reduction catalyst.

The rear-end catalyst may include a second carrier including ceria (CeO₂), alumina (Al₂O₃), titania (TiO₂), zirconia (ZrO₂), or a combination thereof, and a noble metal supported on the second carrier and including platinum (Pt), palladium (Pd), rhodium (Rh), gold (Au), or a combination thereof.

The rear-end catalyst may further include a hydrocarbon storage material supported on the carrier and including barium (Ba), ceria (CeO₂), potassium (K), or a combination thereof.

The vehicle exhaust gas purification device may include about 50 wt % to about 90 wt % of the rear-end catalyst and about 10 wt % to about 50 wt % of a front-end catalyst. The cerium-zirconium composite oxide may further comprise a functional element including La, Y, Pr, Nd, or a combination thereof. The cerium-zirconium composite oxide may be selected from the group consisting of Pd/Ce_{0.4}Zr_{0.5}La_{0.05}Y_{0.05}O₂, Pd/Ce_{0.31}Zr_{0.45}La_{0.06}Y_{0.12}Nd_{0.06}O₂, Pd/Ce_{0.21}Zr_{0.72}La_{0.02}Nd_{0.05}O₂, Pd/Ce_{0.4}Zr_{0.55}Pr_{0.05}O₂.

In another embodiment, vehicles are provided that comprise an apparatus as disclosed herein.

The hydrocarbon reduction catalyst according to one embodiment has excellent performance in reducing hydrocarbons emitted in a cold start region, which is a low temperature region at the beginning of startup.

### BRIEF DESCRIPTION OF THE DRAWINGS

FIG. 1 is a schematic view of a vehicle exhaust gas purification device according to one embodiment.

FIG. 2 is a graph showing the results of measuring the hydrocarbon storage performance of the catalysts prepared in Comparative Examples at an air-fuel ratio (λ) of 1.05.

FIG. 3 is a graph showing the results of measuring the hydrocarbon storage performance of the catalysts prepared in Comparative Examples at an air-fuel ratio (λ) of 0.95.

FIG. 4 is a graph showing the results of comparing the hydrocarbon storage performance of the catalysts prepared in Comparative Examples at an air-fuel ratio (λ) of 1.05 and 0.95.

FIG. 5 is a graph showing the results of measuring the hydrocarbon storage performance of the catalysts prepared in Comparative Examples according to the palladium content at an air-fuel ratio (λ) of 1.05.

FIG. 6 is a graph showing the results of measuring the hydrocarbon storage performance of the catalysts prepared in Comparative Examples according to the palladium content at an air-fuel ratio (λ) of 0.95.

FIG. 7 is a graph showing the results of hydrocarbon storage performance according to the palladium content at an air-fuel ratio (λ) of 1.05 of the catalyst prepared in Example.

FIG. 8 is a graph showing the results of measuring the hydrocarbon storage performance of catalysts prepared in Examples and Comparative Example according to functional elements at an air-fuel ratio (λ) of 1.05.

FIG. 9 is a graph showing the results of measuring the hydrocarbon storage performance of the catalysts prepared in Examples and Comparative Example before and after aging.

### DETAILED DESCRIPTION OF THE EMBODIMENTS

The advantages, features, and embodiments to be described hereinafter will become apparent from the following description of the embodiments with reference to the accompanying drawings, which is set forth hereinafter. However, the present invention may be not limited to embodiments that are described herein. Although not specifically defined, all of the terms including the technical and scientific terms used herein have meanings understood by ordinary persons skilled in the art. The terms have specific meanings coinciding with related technical references and the present specification as well as lexical meanings. That is, the terms are not to be construed as having idealized or formal meanings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, %, 0.5%, 0.1%, 0.05%, or 0.01% of the stated value. Unless otherwise clear from the context, all numerical values provided herein are modified by the term “about”.

A hydrocarbon reduction catalyst according to one embodiment includes a carrier including a cerium-zirconium complex oxide, and palladium supported on the carrier.

The palladium, which is supported on the cerium-zirconium composite, oxidizes hydrocarbon (HC) and carbon monoxide (CO) and plays a role of increasing a storage amount of the hydrocarbon (HC) in the cerium-zirconium composite oxide and improving heat resistance.

The palladium may be included in an amount of about 1 wt % to about 10 wt %, for example, about 4 wt % to about 5 wt % based on a total weight of the hydrocarbon-reduction catalyst. When the palladium is included in an amount of less than about 1 wt %, the hydrocarbon (HC) storage amount may be reduced, but when the palladium is included in an amount of greater than about 10 wt %, polydispersity of the palladium is deteriorated, the hydrocarbon (HC) storage amount may not be increased.

For example, the cerium-zirconium composite oxide may adsorb and store hydrocarbon at a low temperature of less than or equal to about 150° C. but desorb the hydrocarbon at about 250° C. or higher. The cerium-zirconium composite oxide may be a complex or solid solution of cerium oxide (CeO₂) and zirconium oxide (ZrO₂), for example, a solid compound, in which the cerium oxide (CeO₂) and the zirconium oxide (ZrO₂) form completely uniform phases, that is, a solid solution.

The cerium-zirconium composite oxide may include the cerium oxide in an amount of about 20 wt % to about 60 wt %, for example, about 21 wt % to about 40 wt % based on a total weight of the cerium-zirconium composite oxide. The cerium-zirconium composite oxide may include the zirconium oxide in an amount of about 40 wt % to about 80 wt %, for example, about 45 wt % to about 72 wt % based on the total weight of the cerium-zirconium composite oxide. When the cerium-zirconium composite oxide includes the cerium oxide in an amount of less than about 20 wt %, the hydrocarbon storage amount may be reduced, but when the cerium-zirconium composite oxide includes the cerium oxide in an amount of greater than about 60 wt %, the cerium-zirconium composite oxide may be aged, resultantly deteriorating performance.

The cerium-zirconium composite oxide may further include a functional element including La, Y, Pr, Nd, or a combination thereof. The functional element may further improve the hydrocarbon storage amount of the cerium-zirconium composite oxide.

The cerium-zirconium composite oxide may include a functional element in an amount of about 5 wt % to about 24 wt %, for example about 2 wt % to about 6 wt % of La and about 5 wt % to about 12 wt % of Y based on a total weight of the cerium-zirconium composite oxide. When the content of the functional element is less than about 5 wt %, the hydrocarbon storage amount may be reduced, but when greater than about 24 wt %, the hydrocarbon storage amount may not be greatly increased, and the elements such as Pr, Nd, or the like are expensive and thus may increase a cost.

The hydrocarbon reduction catalyst may be subjected to aging at about 800° C. to about 1000° C. Herein, the hydrocarbon reduction catalyst may have an adsorption amount of propene (C₃H₆) ranging from about 100 μmol/g_{cat} to about 600 μmol/g_{cat} at an air-fuel ratio (λ) of about 1 or more.

Accordingly, the hydrocarbon reduction catalyst may be used to store hydrocarbons in vehicle exhaust gas systems and particularly, to adsorb hydrocarbons emitted in a cold start section until three way catalysts are completely warmed up.

The hydrocarbon may include propene, toluene, ethane, ethene, propane, benzene, xylene, ethylene, 2-methylbutane, formaldehyde, styrene, acetaldehyde, or a combination thereof.

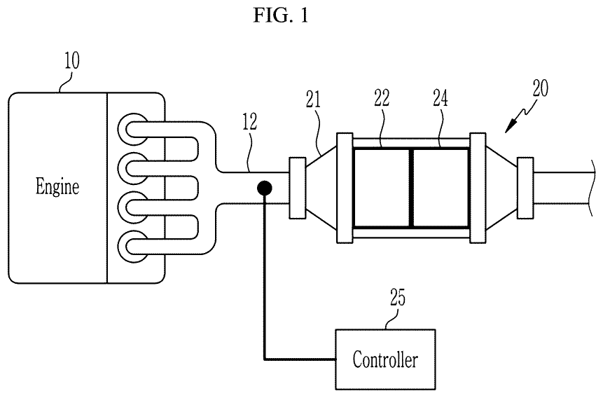

FIG. 1 is a schematic view of a vehicle exhaust gas purification device according to another embodiment.

Hereinafter, the vehicle exhaust gas purification device will be described with reference to FIG. 1.

Referring to FIG. 1, a vehicle exhaust gas purification device 20 is provided on an exhaust pipe 12 connected to an exhaust side of an engine 10 to purify exhaust gas and include a housing 21 disposed on the exhaust pipe 12, a front-end catalyst 22 and a rear-end catalyst 24 built in the housing 21, and a controller 25 controlling a concentration of non-combusted fuel contained in the exhaust gas. FIG. 1 shows a portion of the housing 21 which is cut to show configuration of the front-end catalyst 22 and the rear-end catalyst 24.

The engine 10 may convert chemical energy into mechanical energy by combusting a mixture of a fuel and air. The engine 10 includes plurality of combustion chambers that generate a driving force by combusting the fuel and is connected to an intake manifold to receive the air into the combustion chambers and to an exhaust manifold to gather exhaust gas generated during the combustion and then, discharge the exhaust gas out of the engine 10. In the combustion chambers, an injector is installed to inject the fuel into the combustion chambers.

The exhaust pipe 12 may be connected to the exhaust side of the engine 10 to discharge the exhaust gas emitted from the engine 10 to the outside. On the other hand, the exhaust pipe 12 may extend rearward the under floor of a vehicle to discharge the exhaust gas, wherein disposition of the exhaust pipe 12 and its connection to the exhaust side of the engine 10 are obvious to a person of an ordinary skill in the art (hereinafter, referred to a person skilled in the art) and thus will be omitted.

The exhaust gas emitted from the engine 10 may pass though the exhaust gas purification device 20 while passing the exhaust pipe 12. In addition, the exhaust gas passing through exhaust gas purification device 20 sequentially passes through the front-end catalyst 22 and the rear-end catalyst 24. In other words, a front end of the housing 21 is connected to the engine 10 through the exhaust pipe 12 to receive the exhaust gas emitted from the engine 10, while a rear end of the housing 21 is communicated with the exhaust pipe 12 to discharge the exhaust gas passed through the exhaust gas purification device 20 to the rear of the vehicle. Herein, the front and rear ends of a constituent element are based on a flow of the exhaust gas, and the exhaust gas is defined to flow from the front end to the rear end.

The front-end catalyst 22 may function to store hydrocarbon in the exhaust gas flowing into the housing 21 through the front end of the housing 21. In addition, the front-end catalyst 22 may oxidize carbon monoxide (CO) and store nitrogen oxide (NOx).

The front-end catalyst 22 may be a hydrocarbon reduction catalyst according to one embodiment of the present invention. Description of the hydrocarbon reduction catalyst is the same as above and will not be repeated.

The rear-end catalyst 24 may be disposed at the rear of the front-end catalyst 52 and functions to secondarily purify the exhaust gas passed through the front-end catalyst 22 before it flows out through the rear of the housing 21.

In the rear-end catalyst 24, a noble metal may be supported on a carrier. Precious metals play a role in removing carbon monoxide and hydrocarbon in the lean combustion region and oxidizing nitrogen monoxide (NO) to nitrogen dioxide (NO₂). The noble metal may be platinum (Pt), palladium (Pd), rhodium (Rh), gold (Au), or a combination thereof. The noble metal may be supported in an amount of about 0.1 wt % to about 10 wt % based on a total weight of the rear-end catalyst 24. If too little noble metal is loaded, catalytic activity may be insufficient.

The carrier may serve to support the precious metal. For example, the carrier may be ceria (CeO₂), alumina (Al₂O₃), titania (TiO₂), zirconia (ZrO₂), or a combination thereof. The carrier may be included in an amount of about 65 wt % to about 95 wt % based on a total weight of the rear-end catalyst 24.

The rear-end catalyst 24 may further include a hydrocarbon storage material supported on a carrier along with a noble metal. The hydrocarbon storage material serves to store hydrocarbon oxidized by the noble metal in the lean combustion region.

As an example, the hydrocarbon storage material may use barium (Ba), ceria (CeO₂), potassium (K), or a combination thereof. The hydrocarbon storage material may be supported in an amount of about 1 wt % to about 30 wt % based on a total weight of the rear-end catalyst 24. When the hydrocarbon storage material is too little supported, the storage performance may be insufficient, but when the hydrocarbon storage material is too much supported, which may relatively reduce a region supporting a noble metal, the oxidation performance becomes insufficient.

The vehicle exhaust gas purification device 20 may include about 50 wt % to about 90 wt % of the rear-end catalyst 24 and about 10 wt % to about 50 wt % of the front-end catalyst 22. When the front-end catalyst 24 is too little included, the hydrocarbon storage performance at a low temperature may be deteriorated, but when the front-end catalyst 24 is too much included, since the rear-end catalyst 24 is relatively less included, the hydrocarbon oxidation performance at a high temperature may be deteriorated.

The controller 25 may be connected to the exhaust pipe 12 at the front end of the housing 21 to control a concentration of non-combusted fuel included in the exhaust gas according to a temperature of the exhaust gas flowing into the housing 21 and a vehicle speed.

The controller 25 may have a temperature sensor connected to itself to detect the temperature of the exhaust gas flowing through the exhaust pipe 12 connected to the front end of the housing 21 and also, a speed sensor connected to itself to detect the speed vehicle. In addition, in order to collect information of the air-fuel ratio (λ), an oxygen sensor connected to the controller 25 may be used.

The controller 25 may control the concentration of the non-combusted fuel contained in the exhaust gas flowing into the housing 21 after starting the engine 10 to make the fuel slightly lean. The controller controls the concentration of the non-combusted fuel included in the exhaust gas to have different leanness depending on a temperature of the exhaust gas flowing into the housing 21.

The controller 25 may terminate the leanness, when the exhaust gas has a predetermined temperature (T) or higher or when the vehicle speed reaches a predetermined speed (V) or higher.

The controller 25 may control an air-fuel ratio (λ) of the non-combusted fuel included in the exhaust gas flowing into the housing 21 to less than about 1.08, when the exhaust gas temperature is lower than the predetermined temperature (T) and when the vehicle speed is lower than the predetermined speed (V), while the vehicle gear is in neutral (N). Herein, the predetermined temperature (T) may be in a range of greater than or equal to about 450° C. and less than about 500° C., and the predetermined speed (V) may be about 3 km/h.

In addition, the controller 25, when the exhaust gas flowing into the housing 21 has a lower temperature than the predetermined temperature (T), the vehicle speed is lower than the predetermined speed (V), while the vehicle gear in driving (D, may control an air-fuel ratio (λ) of the non-combusted fuel included in the exhaust gas flowing into the housing 21 to less than about 1.05.

Hereinafter, specific examples of the present disclosure are presented. However, the examples described below are only for specifically illustrating or explaining the present disclosure, and the scope of the invention is not limited thereto.

### Preparation Example: Preparation of Hydrocarbon Reduction Catalyst

### Example 1

A cerium-zirconium composite oxide is prepared in a co-precipitation method. The cerium nitrate hexahydrate (Ce(NO₃)₃ 6H₂O) and a zirconyl chloride (ZrOCl₂8H₂O) precursor in a desired weight ratio of CeO₂:ZrO₂ are dissolved in distilled water. Herein, when a functional element is added to the cerium-zirconium composite oxide, a precursor including the functional element is further added thereto.

Subsequently, an ammonia aqueous solution is injected into the prepared solution until pH becomes 10 to precipitate the cerium-zirconium hydroxide. The produced precipitate is filtered and then, washed with distilled water until the pH is not changed. The washed precipitated are baked at 500° C. for 5 hours to obtain cerium-zirconium composite oxide.

After dissolving palladium (II) nitrate dihydrate (Pd(NO₃)₂·2H₂O) as a palladium (Pd) precursor in distilled water to prepare a precursor solution, the cerium-zirconium composite oxide in powder form is added thereto and then, stirred for 1 hour and treated with a rotary evaporator to evaporate the water and support palladium on the cerium-zirconium composite oxide.

Subsequently, the palladium-supported cerium-zirconium composite oxide is dried at 100° C. for about 12 hour or more and baked at 600° C. for 6 hours to prepare a catalyst. In the catalyst, a content of the palladium supported on the cerium-zirconium composite oxide is 2 wt %.

### Examples 1-2 to 1-6

A catalyst is prepared in the same manner as in Example 1 except that the content of palladium is changed respectively into 1 wt %, 3 wt %, 4 wt %, 5 wt %, and 10 wt %.

### Example 2

A catalyst is prepared in the same manner as in Example 1 except that after preparing Ce_{0.4}Zr_{0.5}La_{0.05}Y_{0.05}O₂ by further adding La and Y as a functional element during the preparation of the cerium-zirconium composite oxide of Example 1, palladium is supported thereon.

### Example 3

A catalyst is prepared in the same manner as in Example 1 except that after preparing Ce_{0.31}Zr_{0.45}La_{0.06}Y_{0.12}Nd_{0.06}O₂ by further adding La, Y, and Nd as a functional element during the preparation of the cerium-zirconium composite oxide of Example 1, palladium is supported thereon.

### Example 4

A catalyst was prepared in the same manner as in Example 1 except that after preparing Ce_{0.21}Zr_{0.72}La_{0.02}Nd_{0.05}O₂ by further adding La and Nd as a functional element during the preparation of the cerium-zirconium composite oxide of Example 1, palladium is supported thereon.

### Example 5

A catalyst was prepared in the same manner as in Example 1 except that after preparing Ce_{0.4}Zr_{0.55}Pr_{0.05}O₂ by further adding Pr as a functional element during the preparation of the cerium-zirconium composite oxide of Example 1, palladium is supported thereon.

### Comparative Example 1

A catalyst is prepared in the same manner as in Example 1 except that CeO₂ is used instead of the cerium-zirconium composite oxide in Example 1, and palladium is not supported thereon.

### Comparative Example 2

A catalyst is prepared in the same manner as in Example 1 except that CeO₂ is used instead of the cerium-zirconium composite oxide of Example 1.

### Comparative Example 2-2 to Comparative Example 2-6

A catalyst is prepared in the same manner as in Example 1 except that the content of palladium in the catalyst prepared in Comparative Example 2 is changed respectively to 1 wt %, 3 wt %, 4 wt %, 5 wt %, and 10 wt %.

### Comparative Example 3

A catalyst is prepared in the same manner as in Example 1 except that CeO₂ is used instead of the cerium-zirconium composite oxide, and platinum (Pt) instead of the palladium is supported thereon.

### Comparative Example 4

A catalyst is prepared in the same manner as in Example 1 except that CeO₂ is used instead of the cerium-zirconium composite oxide, and 1 wt % of palladium and 1 wt % of platinum are supported thereon.

### Comparative Example 5

A catalyst is prepared in the same manner as in Example 1 except that CeO₂ is used instead of the cerium-zirconium composite oxide, and rhodium (Rh) instead of the palladium is supported thereon.

### Comparative Example 6

A catalyst is prepared in the same manner as in Example 1 except that Al₂O₃ is used instead of the cerium-zirconium composite oxide.

### Comparative Example 7

A catalyst is prepared in the same manner as in Example 1 except that Al₂O₃ is used instead of the cerium-zirconium composite oxide, and platinum (Pt) instead of the palladium is supported thereon.

### Comparative Example 8

A catalyst is prepared in the same manner as in Example 1 except that Al₂O₃ is used instead of the cerium-zirconium composite oxide, and rhodium (Rh) instead of the palladium is supported thereon.

### Comparative Example 9

A catalyst is prepared in the same manner as in Example 1 except that TiO₂ is used instead of the cerium-zirconium composite oxide.

### Experimental Example 1: Evaluation of Catalyst Performance According to Combination of Active Metal and Support

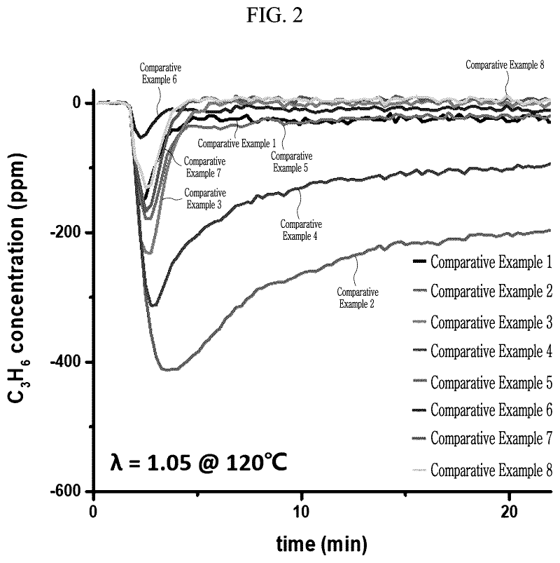

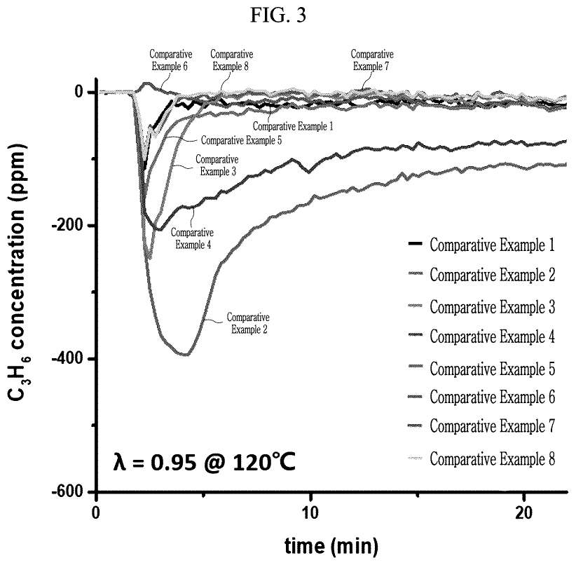

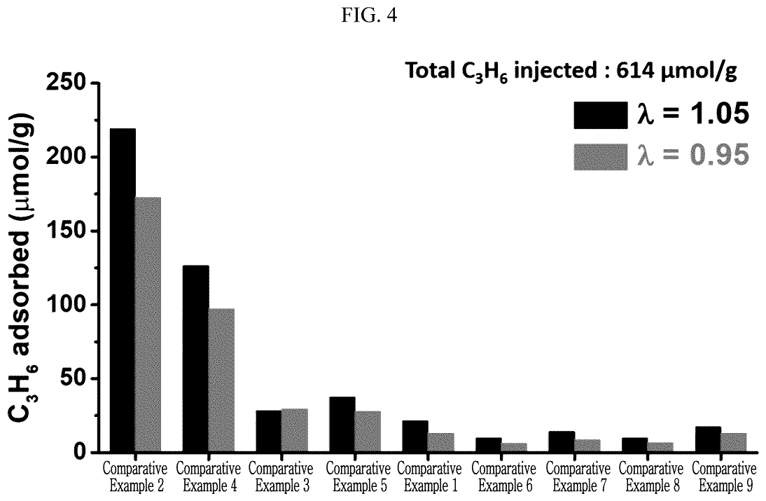

Each of the catalysts of Comparative Examples 1 to 8 is evaluated with respect to hydrocarbon storage performance. The results are shown in FIGS. 2 and 3, and the results of FIG. 2 and FIG. 3 are summarized in FIG. 4.

FIG. 2 shows the propene (C₃H₆) storage performance results at an air-fuel ratio (λ) of 1.05 and a temperature of 120° C., and FIG. 3 shows the propene (C₃H₆) storage performance results at an air-fuel ratio (λ) of 0.95 and a temperature of 120° C. Herein, the condition of an air-fuel ratio (λ) of 0.95 includes 100 ppm NO, 5% H₂O, 5% CO₂, 0.5% O₂, 6000 ppm CO, 2000 ppm H₂, and 1000 ppm C₃H₆, and the condition pf an air-fuel ratio (λ) of 1.05 includes 100 ppm NO, 5% H₂O, 5% CO₂, 1.35% O₂, 6000 ppm CO, 2000 ppm H₂, and 1000 ppm C₃H₆.

Referring to FIGS. 2 and 3, hydrocarbon (C₃H₆) is not almost adsorbed on the Pt and Rh-based catalysts but adsorbed only on a combination of Pd and CeO₂.

In addition, referring to FIG. 4, as a result of quantifying and comparing the adsorbed amounts for initial 10 minutes, Pd/CeO₂ exhibits the most excellent performance and particularly, higher adsorption performance at an air-fuel ratio (λ) of 1.05.

### Experimental Example 2: Evaluation of Catalyst Performance According to Palladium Content

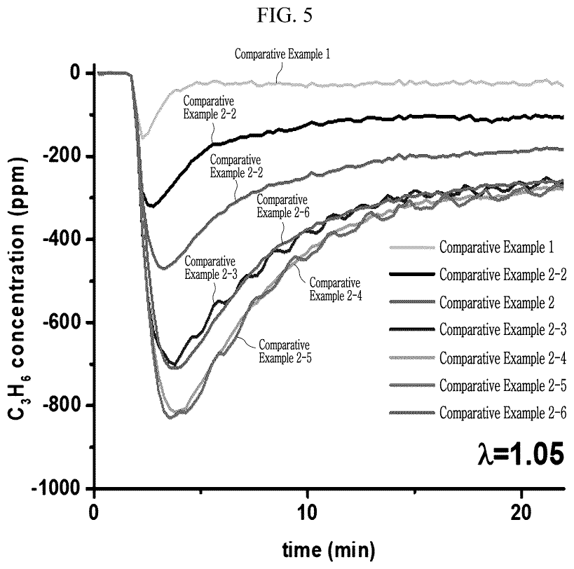

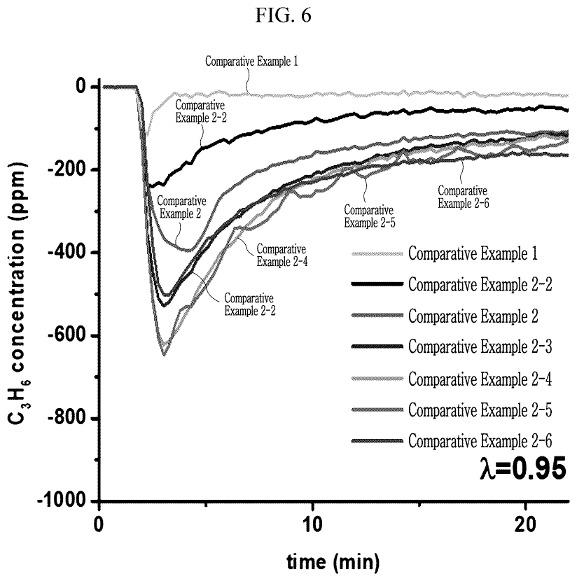

The catalysts of Comparative Examples 1, 2, and 2-2 to 2-6 are evaluated with respect to hydrocarbon storage performance, and the results are shown in FIGS. 5 and 6.

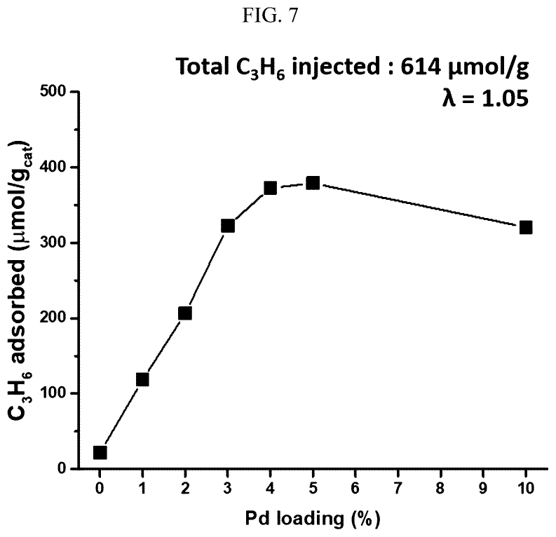

In addition, the catalysts of Examples 1 and 1-2 to 1-6 are evaluated with respect to hydrocarbon storage performance, and the results are shown in FIG. 7.

FIGS. 5 and 7 show the propene (C₃H₆) storage performance results at an air-fuel ratio (λ) of 1.05 and a temperature of 120° C., and FIG. 6 shows the propene (C₃H₆) storage performance results at an air-fuel ratio (λ) of 0.95 and a temperature of 120° C. Herein, the condition of an air-fuel ratio (λ) of 0.95 includes 100 ppm NO, 5% H₂O, 5% CO₂, 0.5% O₂, 6000 ppm CO, 2000 ppm H₂, and 1000 ppm C₃H₆, and the condition of an air-fuel ratio (λ) of 1.05 includes 100 ppm NO, 5% H₂O, 5% CO₂, 1.35% O₂, 6000 ppm CO, 2000 ppm H₂, and 1000 ppm C₃H₆.

Referring to FIGS. 5 and 6, as a result of evaluating the hydrocarbon storage performance of the Pd/CeO₂ catalysts, according as the content of palladium is changed from 1 wt % to 10 wt %, storage performance is improved as the content of palladium is increased to a predetermined level.

Referring to FIG. 7, under the condition of an air-fuel ratio (λ) of 1.05 at which the hydrocarbon storage performance is excellent, the catalysts of the examples exhibit the most excellent performance, when the content of palladium is 4 wt % to 5 wt %.

### Experimental Example 3: Evaluation of Catalyst Performance According to Functional Elements

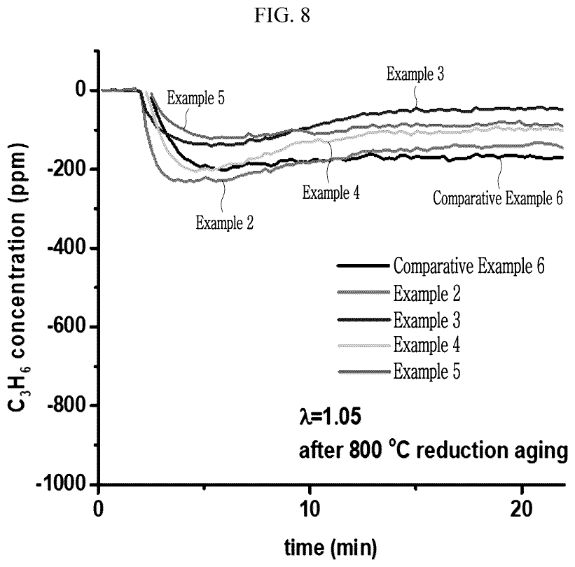

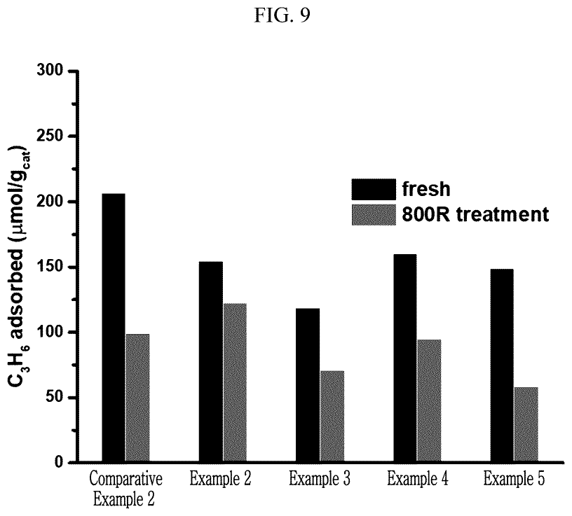

The catalysts of Comparative Example 2 and Examples 2 to 5 are evaluated with respect to hydrocarbon storage performance, and the results are shown in FIG. 8. In addition, the catalysts of Comparative Example 2 and Examples 2 to 5 are evaluated with respect to hydrocarbon storage performance before and after the aging, and the results are shown in FIG. 9.

FIGS. 8 and 9 show the propene (C₃H₆) storage performance results at an air-fuel ratio (λ) of 1.05 and a temperature of 120° C. In FIG. 9, ‘fresh’ exhibits performance of the catalysts before the aging, while ‘800R treatment’ exhibits performance of the catalysts after the aging. The aging of the catalyst is performed under high temperature reduction conditions of 800° C.

Referring to FIGS. 8 and 9, since durability of a catalyst is important under the high temperature reduction condition, to which the catalyst is continuously exposed, which is equal to the exhaust gas condition of gasoline vehicles, in order to secure the high temperature durability, as a result of evaluating hydrocarbon storage performance of mixed oxides prepared by adding various functional additives such as zirconia to ceria, a Pd/Ce_{0.4}Zr_{0.5}La_{0.05}Y_{0.05}O₂ catalyst turns out to exhibit the highest initial adsorption amount.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

10: engine
12: exhaust pipe
20: exhaust gas purification device
21: housing
22: front-end catalyst
24: rear-end catalyst
25: controller

What is claimed is:

1. A hydrocarbon reduction catalyst, comprising:
a carrier comprising a cerium-zirconium composite oxide, and
palladium,
wherein the palladium is in an amount of about 1 wt % to about 10 wt % based on a total weight of the hydrocarbon reduction catalyst.

2. The hydrocarbon reduction catalyst of claim 1, wherein
the palladium is in an amount of about 4 wt % to about 5 wt % based on a total weight of the hydrocarbon reduction catalyst.

3. The hydrocarbon reduction catalyst of claim 1, wherein
the cerium-zirconium composite oxide is a composite or solid solution of cerium oxide (CeO₂) and zirconium oxide (ZrO₂).

4. The hydrocarbon reduction catalyst of claim 1, wherein
the cerium-zirconium composite oxide comprises cerium oxide in an amount of about 20 wt % to about 60 wt % based on a total weight of the cerium-zirconium composite oxide.

5. The hydrocarbon reduction catalyst of claim 1, wherein
the cerium-zirconium composite oxide comprises zirconium oxide in an amount of about 40 wt % to about 80 wt % based on a total weight of the cerium-zirconium composite oxide.

6. The hydrocarbon reduction catalyst of claim 1, wherein
the cerium-zirconium composite oxide further comprises a functional element comprising La, Y, Pr, Nd, or a combination thereof.

7. The hydrocarbon reduction catalyst of claim 6, wherein
the functional element is in an amount of about 5 wt % to about 24 wt % based on a total weight of the cerium-zirconium composite oxide.

8. The hydrocarbon reduction catalyst of claim 6, wherein
the functional element is in an amount of about 5 wt % to about 12 wt % based on a total weight of the cerium-zirconium composite oxide.

9. The hydrocarbon reduction catalyst of claim 6, wherein
the cerium-zirconium composite oxide is selected from the group consisting of Pd/Ce_{0.4}Zr_{0.5}La_{0.05}Y_{0.05}O₂, Pd/Ce_{0.31}Zr_{0.45}La_{0.06}Y_{0.12}Nd_{0.06}O₂, Pd/Ce_{0.21}Zr_{0.72}La_{0.02}Nd_{0.05}O₂, Pd/Ce_{0.4}Zr_{0.55}Pr_{0.05}O₂, and a combination thereof.

10. The hydrocarbon reduction catalyst of claim 6, wherein the cerium-zirconium composite oxide is Pd/Ce_{0.4}Zr_{0.5}La_{0.05}Y_{0.05}O_{2,}

11. The hydrocarbon reduction catalyst of claim 1, wherein
the hydrocarbon reduction catalyst is configured to be subjected to aging at a temperature of about 800° C. to about 1000° C.

12. The hydrocarbon reduction catalyst of claim 1, wherein
the hydrocarbon reduction catalyst has an adsorption amount of propene (C₃H₆) of about 100 μmol/g_{cat} to about 600 μmol/g_{cat} at an air-fuel ratio (λ) of 1 or more.

13. A vehicle exhaust gas purification device, which is provided on an exhaust pipe connected to an exhaust side of the engine to purify an exhaust gas of an engine, comprising:
a housing disposed on the exhaust pipe and configured to receive the exhaust gas discharged from the engine, pass the received exhaust gas through the vehicle gas purification device, and discharge the passed exhaust gas rearward;
a front-end catalyst built into the housing and configured to store hydrocarbons included in exhaust gas flowing into the housing through a front end of the housing; and
a rear-end catalyst built into the housing and configured to purify exhaust gas passing through the front-end catalyst before it flows out to the rear end of the housing,
wherein the front-end catalyst comprises:
a first carrier comprising a cerium-zirconium composite oxide, and
palladium supported on the first carrier, and
the palladium is in an amount of about 1 wt % to about 10 wt % based on a total weight of the front-end catalyst.

14. The vehicle exhaust gas purification device of claim 13, wherein
the rear-end catalyst comprises a second carrier including ceria (CeO₂), alumina (Al₂O₃), titania (TiO₂), zirconia (ZrO₂), or a combination thereof, and
a noble metal supported on the carrier and including comprising platinum (Pt), palladium (Pd), rhodium (Rh), gold (Au), or a combination thereof.

15. The vehicle exhaust gas purification device of claim 13, wherein
the rear-end catalyst further comprises a hydrocarbon storage material supported on the carrier and including barium (Ba), ceria (CeO₂), potassium (K), or a combination thereof.

16. The vehicle exhaust gas purification device of claim 13, wherein
the vehicle exhaust gas purification device comprises about 50 wt % to about 90 wt % of the rear-end catalyst and about 10 wt % to about 50 wt % of a front-end catalyst.

17. The hydrocarbon reduction catalyst of claim 13, wherein the palladium is in an amount of about 4 wt % to about 5 wt % based on a total weight of the hydrocarbon reduction catalyst.

18. The hydrocarbon reduction catalyst of claim 13, wherein
the cerium-zirconium composite oxide further comprises a functional element including La, Y, Pr, Nd, or a combination thereof.

19. The hydrocarbon reduction catalyst of claim 13, wherein
the cerium-zirconium composite oxide is selected from the group consisting of Pd/Ce_{0.4}Zr_{0.5}La_{0.05}Y_{0.05}O₂, Pd/Ce_{0.31}Zr_{0.45}La_{0.06}Y_{0.12}Nd_{0.06}O₂, Pd/Ce_{0.21}Zr_{0.72}La_{0.02}Nd_{0.05}O₂, Pd/Ce_{0.4}Zr_{0.55}Pr_{0.05}O₂.

20. A vehicle comprising the hydrocarbon reduction catalyst of claim 1.
